(19) United States
(12) Patent Application Publication
(10) Pub. No.: US 2015/0085189 A1
(43) Pub. Date: Mar. 26, 2015

(54) DIGITAL TELEVISION, TELEVISION CHIP AND DISPLAY METHOD

(71) Applicant: NOVATEK MICROELECTRONICS CORP., Hsinchu (TW)

(72) Inventor: Ming-Lin LEE, Hsinchu City (TW)

(73) Assignee: NOVATEK MICROELECTRONICS CORP., Hsinchu (TW)

(21) Appl. No.: 14/253,327

(22) Filed: Apr. 15, 2014

(30) Foreign Application Priority Data
Sep. 24, 2013 (TW) 102134345

(51) Int. Cl. H04N 7/01

(52) U.S. Cl. CPC H04N 7/012
USPC 348/446

(57) ABSTRACT

A digital television (TV) including a display terminal, a TV chip and an image driving circuit is provided. The display terminal includes multiple adjacent rows of pixels. The TV chip includes a digital TV decoder, a data stream decoder, a scaler and a color space converting circuit. The digital TV decoder outputs a data stream according to an interlaced TV signal. The data stream decoder decodes the data stream to output an interlaced image. The scaler outputs a scaled image according to the interlaced image. The color space converting circuit outputs color pixel data according to the scaled image. The image driving circuit simultaneously turns on the rows of pixels, and writes the color pixel data into the rows of pixels to display a de-interlaced image.

This application claims the benefit of Taiwan application Serial No. 102134345, filed Sep. 24, 2013, the subject matter of which is incorporated herein by reference.

### BACKGROUND OF THE INVENTION

1. Field of the Invention

The invention relates in general to an electronic apparatus, and more particularly to a digital television (TV), a TV chip and a display method.

2. Description of the Related Art

Under the National Television System Committee (NTSC) standard, a TV presents 60 successive frames per second. When transmitting video signals via TV stations or storing video signals in storage media, there are usually limitations of transmission bandwidth or storage capacity. Further, a display device is also often limited by a scanning frequency. To be unconfined from these limitations, image signals of each frame are usually divided into a half by interlacing the video signals to form interlaced images in a reduced data amount.

However, as each frame of an interlaced image constitutes only a half of an original frame, a conventional TV chip requires a de-interlacing circuit, which de-interlaces the interlaced image to duplicate data of previous-row pixels to next-row pixels. Further, a conventional TV chip also needs a data buffer for buffering the previous-row data duplicated by the de-interlacing circuit. As a result, production costs are increased and product competitiveness is lowered.

### SUMMARY OF THE INVENTION

The invention is directed to a TV chip, a digital TV and a display method.

A digital TV is provided by the present invention. The digital TV includes a display terminal, a TV chip and an image driving circuit. The display terminal includes a plurality of adjacent rows of pixels. The TV chip includes a digital TV decoder, a data stream decoder, a scaler, and a color space converting circuit. The TV decoder outputs a data stream according to an interlaced TV signal. The data stream decoder decodes the data stream to output an interlaced image. The scaler outputs a scaled image according to the interlaced image. The color space converting circuit outputs color pixel data according to the scaled image. The image driving circuit simultaneously turns on the rows of pixels, and writes the color pixel data into the rows of pixels to display a de-interlaced image.

A TV chip is provided by the present invention. The TV chip includes a digital TV decoder, a data stream decoder, a scaler and a color space converting circuit. The TV decoder outputs a data stream according to an interlaced TV signal. The data stream decoder decodes the data stream to output an interlaced image. The scaler outputs a scaled image according to the interlaced image. The color space converting circuit outputs color pixel data according to the scaled image. The image driving circuit simultaneously turns on the rows of pixels, and writes the color pixel data into the rows of pixels to display a de-interlaced image.

A display method is further provided by the present invention. The display method includes: outputting a data stream according to an interlaced TV signal; decoding the data stream to output an interlaced image; outputting a scaled image according to the interlaced image; outputting color pixel data according to the scaled image; and simultaneously turning on a plurality of adjacent rows of pixels, and writing the color pixel data into the rows of pixels to display a de-interlaced image.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a structure of a digital TV according to a first embodiment of the present invention;

FIG. 2 is a schematic diagram of an output circuit and a display terminal according to the first embodiment of the present invention;

FIG. 3 is a timing diagram of gate driving signals according to the first embodiment of the present invention;

FIG. 4 is a flowchart of a display method according to the first embodiment of the present invention; and

FIG. 5 is a structure of a digital TV according to a second embodiment of the present invention.

### DETAILED DESCRIPTION OF THE INVENTION

### First Embodiment

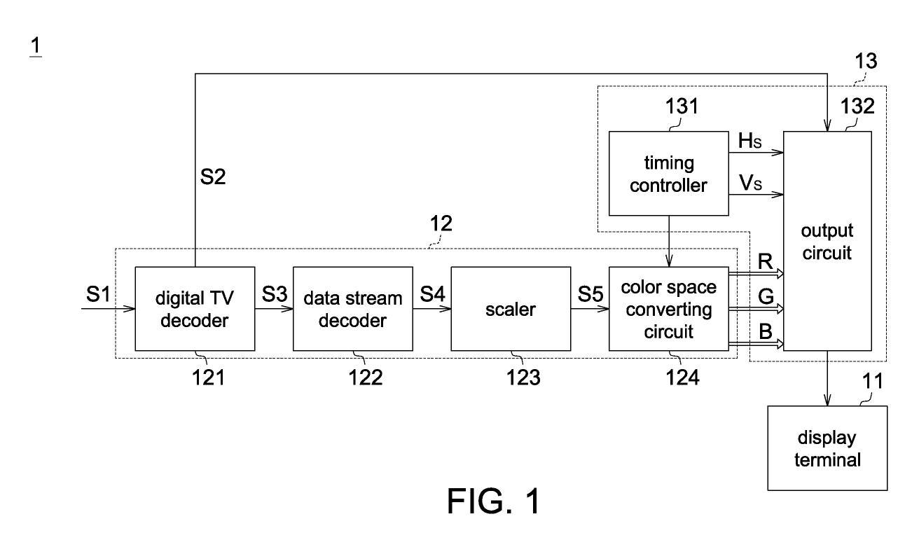

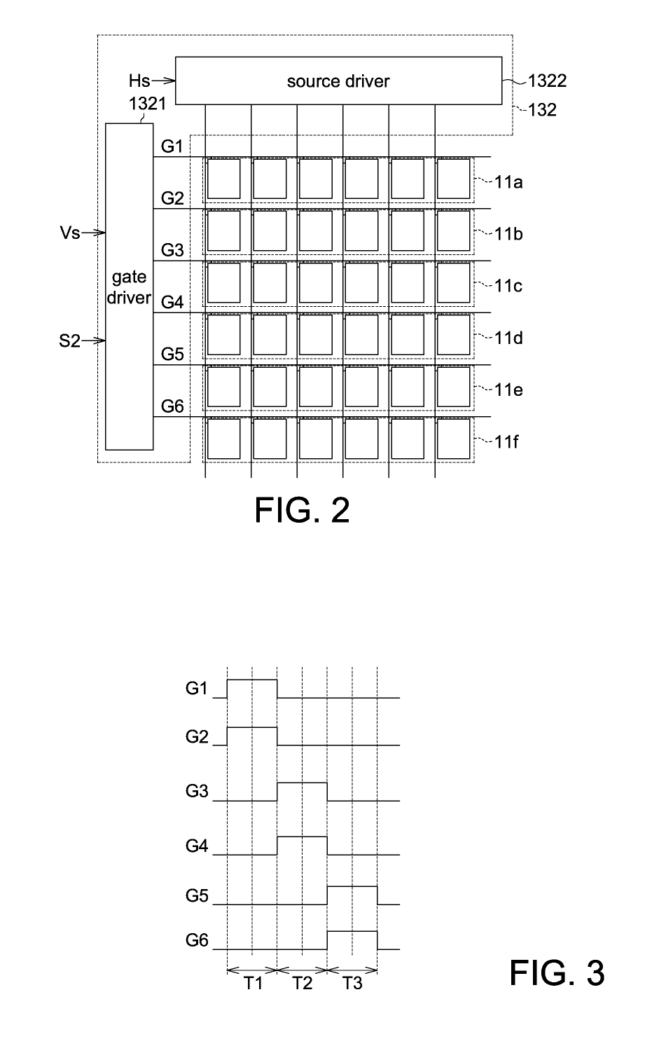

FIG. 1 shows a structure of a digital TV according to a first embodiment of the present invention. FIG. 2 shows a schematic diagram of an output circuit and a display terminal according to the first embodiment of the present invention. FIG. 3 shows a timing diagram of gate driving signals according to the first embodiment of the present invention. Referring to FIGS. 1, 2 and 3, a digital TV 1 includes a display terminal 11, a TV chip 12 and an image driving circuit 13. For example, the display terminal 11 is a liquid crystal display (LCD) or cathode ray tube (CRT) display device, and the TV chip 12 is a digital TV chip.

The display terminal 11 includes a first-row pixels 11a, second-row pixels 11b, third-row pixels 11c, fourth-row pixels 11d, fifth-row pixels 11e and sixth-row pixels 11f. The second-row pixels 11b are adjacent to the first-row pixels 11a, the fourth-row pixels 11d are adjacent to the third-row pixels 11c, and the sixth-row pixels 11f are adjacent to the fifth-row pixels 11e. The TV chip 12 includes a digital TV decoder 121, a data stream decoder 122, a scaler 123 and a color space converting circuit 124. The digital TV decoder 121 outputs a data stream S3 and an indication signal S2 according to an interlaced TV signal S1. The data stream decoder 122 decodes the data stream S3 to output an interlaced image S4. The scaler 123, connected to the data stream decoder 122, outputs a scaled image S5 according to the interlaced image S4. The color space converting circuit 124 outputs color pixel data according to the scaled image S5. The color pixel data includes red pixel data R, green pixel data G and blue pixel data B. For example, the color space of the scaled image S5 is YCbCr, and the color space of the color pixel data is RGB.

The image driving circuit 13 simultaneously turns on two adjacent rows of pixels according to the indication signal S2, and writes the color pixel data into the two adjacent rows of pixels. The image driving circuit 13 includes a timing controller 131 and an output circuit 132. For example, the output circuit 132 is a digital output circuit or an analog output circuit. The timing controller 131 controls the color space converting circuit 124, and outputs a horizontal synchronization signal Hs and a vertical synchronization signal Vs to the output circuit 132. The output circuit 132 simultaneously turns on two adjacent rows of pixels according to the vertical synchronization signal Vs and the indication signal S2, and writes the color pixel data into two adjacent rows of pixels according to the horizontal synchronization signal Hs to display a de-interlaced image.

The output circuit 132 further includes a gate driver 1321 and a source driver 1322. The gate driver 1321 generates gate driving signals G1 to G6 according to the indication signal S2 and the vertical synchronization signal Vs. The source driver 1322 writes the color pixel data into the corresponding pixels according to the horizontal synchronization signal Hs. For example, the source driver 1322 simultaneously turns on the first-row pixels 11a and the second-row pixels 11b in a charging period T1 according to the gate driving signals G1 and G2 generated based on the horizontal synchronization signal Hs. The source driver 1322 writes the color pixel data into the first-row pixels 11a and the second-row pixels 11b. Next, the source driver 1322 simultaneously turns on the third-row pixels 11c and the fourth-row pixels 11d in a charging period T2 according to the gate driving signals G3 and G4 generated based on the horizontal synchronization signal Hs. The source driver 1322 writes the color pixel data into the third-row pixels 11c and the fourth-row pixels 11d. Next, the source driver 1322 simultaneously turns on the fifth-row pixels 11e and the sixth-row pixels 11f in a charging period T3 according to the gate driving signals G5 and G6 generated based on the horizontal synchronization signal Hs. The source driver 1322 writes the color pixel data into the fifth-row pixels 11e and the sixth-row pixels 11f.

It should be noted that, the TV chip 12 does not involve any de-interlacing circuit. In the first embodiment, the gate driver 1321 simultaneously turns on two adjacent rows of pixels to achieve a same effect as a de-interlacing circuit. Further, since two adjacent rows of pixels are simultaneously turned on in the first embodiment, the charging time may be increased to twice of that of the conventional solution that sequentially turns on one row of pixels after another row of pixels. In addition, the TV chip 12 does not require an additional data buffer for buffering previous-row data duplicated by the de-interlacing circuit. Further, as no de-interlacing circuit that duplicates the previous-row data is included in the TV chip, a transmission bandwidth of the data stream S3 is equal to a transmission bandwidth of the scaled image S5.

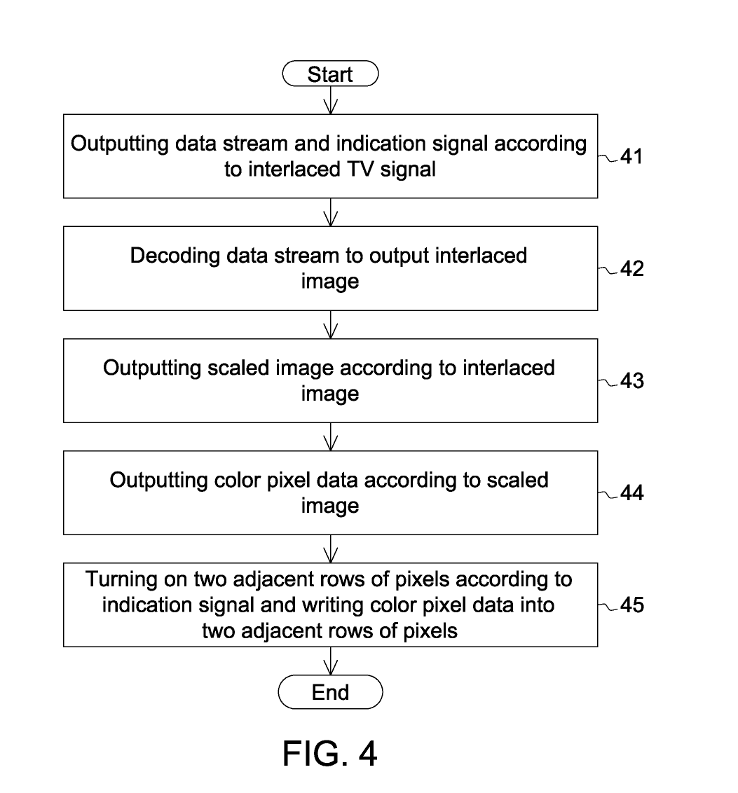

FIG. 4 shows a flowchart of a display method according to the first embodiment of the present invention. Referring to FIGS. 1 and 4, the display method, applicable to the digital TV 1, includes the following steps. In step 41, the digital TV decoder 21 outputs the data stream S3 and the indication signal S2 according to the interlaced TV signal S1. In step 42, the data stream decoder 122 decodes the data stream S3 to output the interlaced image S4. In step 43, the scaler 123 outputs the scaled image S5 according to the interlace image S4. In step 44, the color space converting circuit 124 outputs color pixel data according to the scaled image S5. In step 45, the image driving circuit 13 simultaneously turns on two adjacent rows of pixels according to the indication signal S2, and writes the color pixel data into the two adjacent rows of pixels.

### Second Embodiment

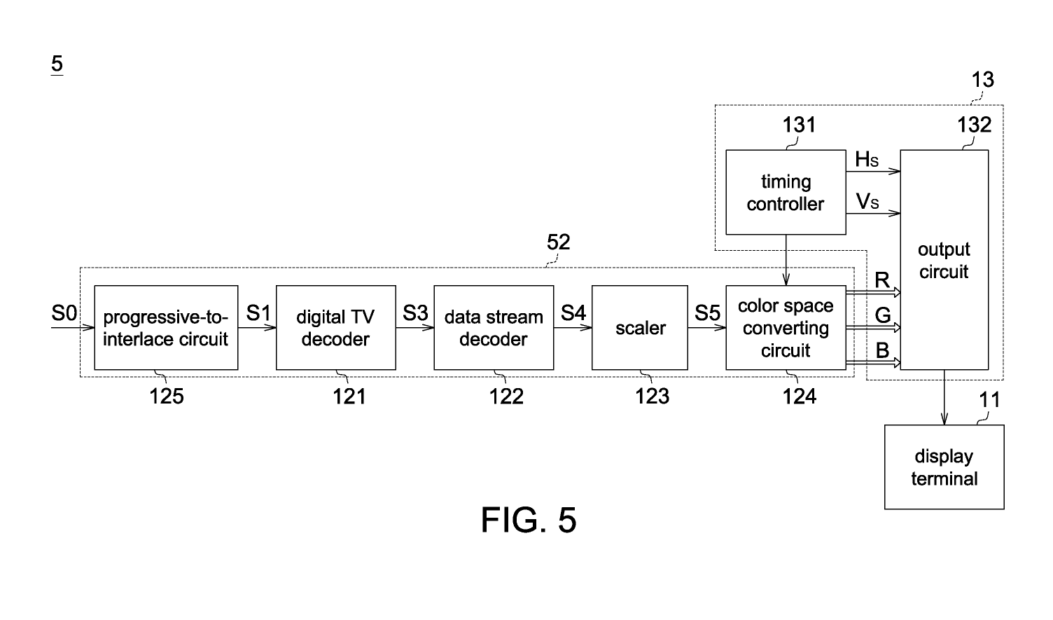

FIG. 5 shows a structure of a digital TV according to a second embodiment of the present invention. Referring to FIGS. 1 and 5, a main difference of a digital TV 5 in the second embodiment from the first embodiment is that, a TV chip 52 further includes a progressive-to-interlace circuit 125. The progressive-to-interlace circuit 125 converts a progressive TV signal S0 to an interlaced TV signal S1. Compared to the first embodiment, the digital TV 5 in the second embodiment does not require the indication signal S2 for indicating whether the TV signal is progressive or interlaced. Regardless of whether the TV signal is progressive or interlaced, the progressive-to-interlace circuit 125 converts the TV signal to the interlaced TV signal S1. As such, for whether the digital TV 5 receives the progressive TV signal S0 or the interlaced TV signal S1, a de-interlacing function can be achieved by simultaneously turning on two adjacent rows of pixels.

In the above embodiments, by simultaneously turning on two adjacent rows of pixels, a de-interlacing function is achieved without additionally utilizing a de-interlacing circuit. Further, in the above embodiments, as two adjacent rows of pixels are simultaneously turned on, the charging period may be twice of that of the conventional solution that turns on one row of pixels after another row of pixels, and thus an additional data buffer need not be included in the TV chip.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A digital television (TV), comprising:
a display terminal, comprising a plurality of adjacent rows of pixels;
a TV chip, comprising:
a digital TV decoder, configured to output a data stream according to an interlaced signal;
a data stream decoder, configured to decode the data stream to output an interlaced image;
a scaler, configured to output a scaled image according to the interlaced image; and
a color space converting circuit, configured to output color pixel data according to the scale image; and
an image driving circuit, configured to simultaneously turn on the plurality of rows of pixels, and to write the color pixel data into the plurality of rows of pixels to display a de-interlaced image.

2. The digital TV according to claim 1, further comprising:
a progressive-to-interlace circuit, configured to convert a progressive TV signal to the interlaced TV signal.

3. The digital TV according to claim 1, wherein the digital TV decoder further outputs an indication signal according to the interlaced TV signal, and the image driving circuit simultaneously turns on the plurality of rows of pixels according to the indication signal.

4. The digital TV according to claim 3, wherein the image driving circuit comprises:
a timing controller, configured to control the color space converting circuit, and to output a horizontal synchronization signal and a vertical synchronization signal to the output circuit; and
an output circuit, configured to simultaneously turn on the plurality of rows of pixels according to the vertical synchronization signal and the indication signal, and to write the color pixel data into the plurality of rows of pixels according to the horizontal synchronization signal.

5. The digital TV according to claim 4, wherein the output circuit comprises:
a gate driver, configured to simultaneously turn on the plurality of rows of pixels according to the indication signal.

6. The digital TV according to claim 4, wherein a transmission bandwidth of the data stream is equal to a transmission bandwidth of the scaled image.

7. The digital TV according to claim 4, wherein the output circuit is a digital output circuit.

8. The digital TV according to claim 4, wherein the output circuit is an analog output circuit.

9. The digital TV according to claim 1, wherein the scaler is connected to the data stream decoder.

10. ATV chip, comprising:
a digital TV decoder, configured to output a data stream according to an interlaced signal;
a data stream decoder, configured to decode the data stream to output an interlaced image;
a scaler, configured to output a scaled image according to the interlaced image; and
a color space converting circuit, configured to output color pixel data to an image driving circuit according to the scale image, such that the image driving circuit simultaneously turns on a plurality of adjacent rows of pixels and writes the color pixel data into the plurality of rows of pixels to display a de-interlaced image.

11. The TV chip according to claim 10, further comprising:
a progressive-to-interlace circuit, configured to convert a progressive TV signal to the interlaced TV signal.

12. The TV chip according to claim 10, wherein the digital TV decoder further outputs an indication signal according to the interlaced TV signal, and the image driving circuit simultaneously turns on the plurality of rows of pixels according to the indication signal.

13. The TV chip according to claim 12, wherein the output circuit comprises:
a gate driver, configured to simultaneously turn on the plurality of rows of pixels according to the indication signal.

14. The TV chip according to claim 10, wherein a transmission bandwidth of the data stream is equal to a transmission bandwidth of the scaled image.

15. The TV chip according to claim 10, wherein the scaler is connected to the data stream decoder.

16. A display method, comprising:
outputting a data stream and an indication signal according to an interlaced TV signal;
decoding the data stream to output an interlaced image;
outputting a scaled image according to the interlaced image;
outputting color pixel data according to the scaled image; and
simultaneously turning on a plurality of adjacent rows of pixels according to the indication signal, and writing the color pixel data into the plurality of rows of pixels to display a de-interlaced image.

17. The display method according to claim 16, further comprising:
converting a progressive TV signal to the interlaced TV signal.

18. The display method according to claim 16, wherein the step of outputting the data stream further outputs an indication signal according to the interlaced TV signal, and the step of turning on the plurality of rows of pixels turns on the plurality of rows of pixels according to the indication signal.

19. The display method according to claim 18, wherein the step of turning on the plurality of rows of pixels turns on the plurality of rows of pixels by a gate driver according to the indication signal.

20. The display method according to claim 16, wherein a transmission bandwidth of the data stream is equal to a transmission bandwidth of the scaled image.
